(19) United States
(12) Patent Application Publication
(10) Pub. No.: US 2016/0008890 A1
(43) Pub. Date: Jan. 14, 2016

(54) OUTSIDE CHAMFERING TOOL

(71) Applicant: John E. Rishton, Cathedral City, CA (US)

(72) Inventor: John E. Rishton, Cathedral City, CA (US)

(21) Appl. No.: 14/327,373

(22) Filed: Jul. 9, 2014

(51) Int. Cl. B23B 27/06; B23C 5/10

(52) U.S. Cl. CPC B23B 27/06; B23C 5/109; B23B 2210/02; B23B 2220/04; B23B 2228/24; B23C 2220/16; B23C 2228/24

(57) ABSTRACT

Improvements in an outside chamfering tool are disclosed. The outside chamfering tool is made from an assembly of pieces. The outside chamfering tool uses multiple removable and replaceable cutters. The use of multiple cutters allows the cutters to create an outside chamfer to a point. The multiple cutters help to center the part being machined by loading the part being chamfered on multiple sides. The outside chamfering tool uses four cutters placed on 90 degree quadrants. The cutting surfaces are resharpened by pushing or pulling the cutting tools out of the holder and then grasping the cutter bits in a grinder where a new cutting surface can be formed on each of the cutting surfaces collectively or individually. The cutting surfaces nest together within the holder with slight interference or friction forces hold the cutters in position.

### CROSS REFERENCE TO RELATED APPLICATIONS

This application claims priority to Provisional application Ser. No. 61/859,405 filed Jul. 29, 2013 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in an outside chamfering tool. More particularly, the present outside chamfering tool uses interchangeable and replaceable cutting bits to cut an outside chamfer.

2. Description of Related Art Including Information Disclosed Under 37 CFR 1.97 and 1.98

In the machining industry one operation is called outside chamfering. This operation requires removal of material from an outside edge of a part. The outside chamfering is similar to the operation that is performed on a pencil where the pencil is sharpened to a point. In the sharpening of a pencil the pencil stays static or is pushed into the sharpening grinder. Other methods of creating an outside chamfer are to turn the part and bring a cutting tool into the turning part. With the use of CNC machines a cutter can revolve a pattern around a static part to create an outside chamfer. Another current method of making an outside chamfer is to make a cutter from powdered metal and the performing a finished grinding operation to make the outside chamfering tool.

A number of patents and or publications have been made to address these issues. Exemplary examples of patents and or publication that try to address this/these problem(s) are identified and discussed below.

U.S. Pat. No. 4,686,751 issued Aug. 18, 1987 to Doyle D. Gracey discloses a Cartridge Case Trimmer. The trimmer uses a single cutter that cuts around the outside of a cartridge disclose. The use of a single blade pushes the material being trimmed away from the cutter as it trims the cartridge. This fine for thin materials or materials that require minimal trimming, but would not be effective to cut a rigid shaft.

U.S. Pat. No. 7,070,364 issued Jul. 4, 2006 to Mark A. Weare discloses a Reverse Chamfer and Countersink tool. The tool uses a single cylindrical cutter with an open central hold. While the cutter provides some chamfering the chamfering won't cut down to a central point.

What is needed is an outside chamfering tool that is less expensive, made from hardened materials, sharpenable and serviceable. The proposed outside chamfering tool provides a solution to this problem.

### BRIEF SUMMARY OF THE INVENTION

It is an object of the outside chamfering tool to be made from an assembly of pieces. The assembly of pieces makes the outside chamfering tool easier and less expensive to manufacture because some of the components can be made from harder materials that can be more brittle while other components can be made from more ductile materials to reduce fracture from impacts. The assembly of components also makes replacement of cutting surfaces more cost effective.

It is an object of the outside chamfering tool to have cutting surfaces made of hardened materials. The hardened materials provide a longer tool life. While softer materials can be used to make producing the parts less expensive the use of some harder materials that can be produced with grinding or heat treating and then grinding produces a longer life outside chamfering tool.

It is another object of the outside chamfering tool to use multiple cutters. The use of multiple cutters allows the cutters to create an outside chamfer to a point. The multiple cutters further help to center the part being machined by loading the part being chamfered on multiple sides. The outside chamfering tool uses ideally four cutters placed on 90 degree quadrants, but could be as few as two, or three to more than four cutting tools and surfaces.

It is still another object of the outside chamfering tool for the cutting surfaces to be resharpenable. The cutting surfaces are resharpened by pushing or pulling the cutting tools out of the holder and then grasping the cutter bits in a grinder where a new cutting surface can be formed on each of the cutting surfaces collectively or individually. The cutting surfaces nest together within the holder with slight interference or friction forces hold the cutters in position. The multiple cutting tools are identically ground to product equal cutting from each bit.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows an angled perspective view of an outside chamfering tool.

FIG. 2 shows a front perspective view of the outside chamfering tool.

FIG. 3 shows a front view of the outside chamfering tool.

FIG. 4 shows a bottom view of the outside chamfering tool.

FIG. 5 shows a top view of the outside chamfering tool.

FIG. 6 shows a cross-sectional view of the outside chamfering tool from FIG. 5.

FIG. 7 shows a perspective view of just the holder.

FIG. 8 shows a perspective view of the tool holder with a single cutter installed in the holder.

FIG. 9 shows a perspective view of a single cutter.

FIG. 10 shows a top or bottom view of a single cutter.

FIG. 11 shows a first side view of a single cutter.

FIG. 12 shows a second side view of a single cutter.

FIG. 13 shows a third side view of a single cutter.

FIG. 14 shows a fourth side view of a single cutter.

### DETAILED DESCRIPTION OF THE INVENTION

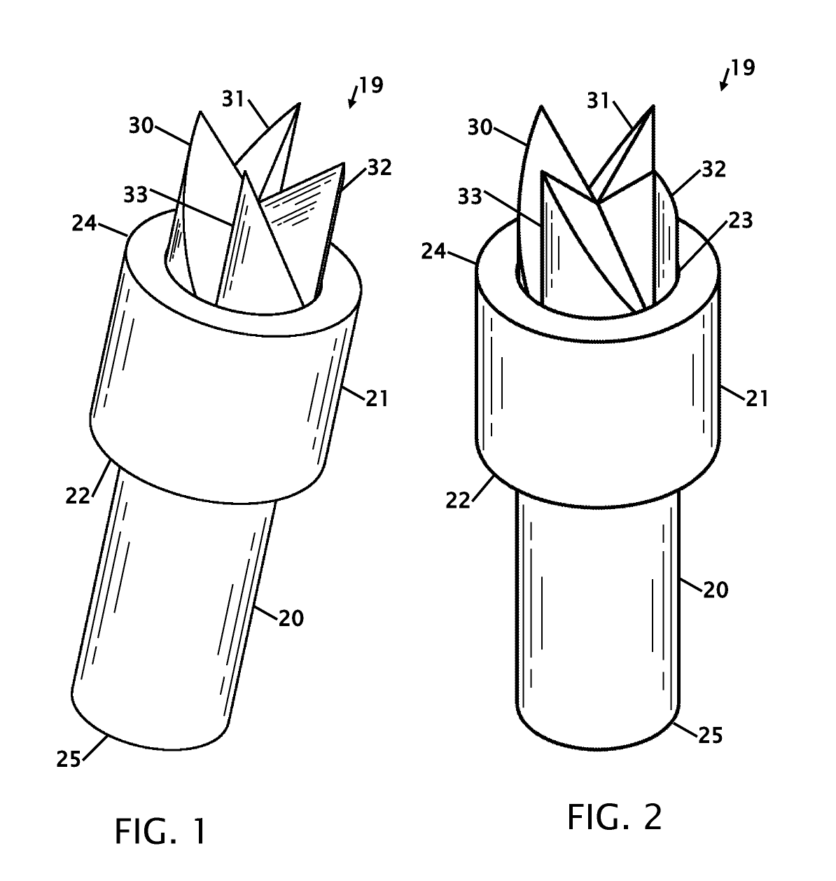

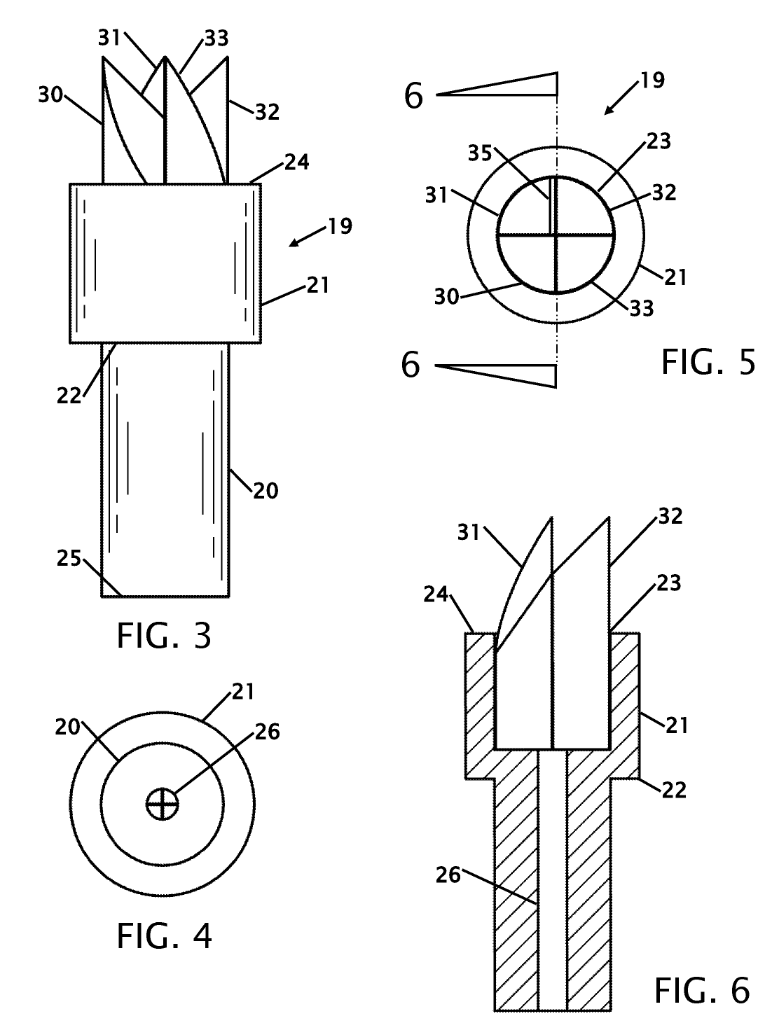

FIG. 1 shows an angled perspective view of an outside chamfering tool 19, FIG. shows a front perspective view of the outside chamfering tool 19, FIG. 3 shows a front view of the outside chamfering tool 19 and FIG. 4 shows a bottom view of the outside chamfering tool 19. These figures show the multiple cutting bits 30, 31, 32 and 33 within the tool holder. The tool holder has essentially an elongated cylindrical body with a first end 20 having a cylindrical shaft 20 that fits within the chuck, collet or other similar tool holder. In the embodiment shown the cylindrical shaft 20 has straight side walls but could also be tapered to fit directly within the receiver of a milling machine, lath or CNC machine holder. The cylindrical shaft 20 has a bottom 25 that is essentially flat. The cylindrical shaft further has a shoulder 22 to prevent inserting the outside chamfering tool 19 too far into a collet or chuck.

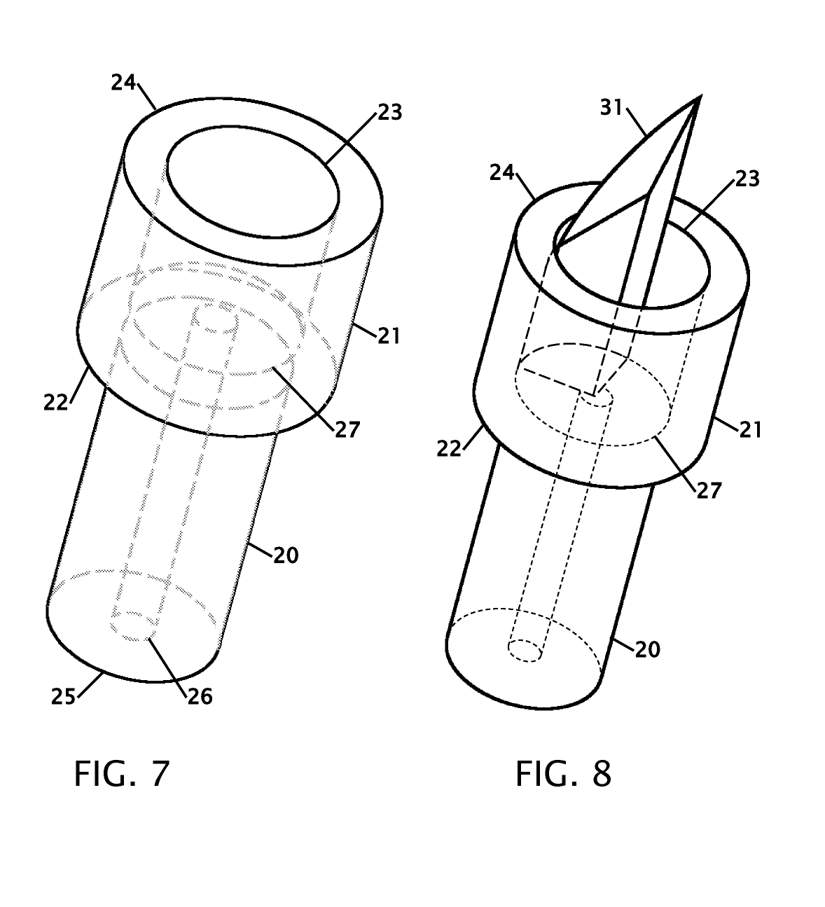

The middle section 21 of the outside chamfering tool 19 has straight walls that allow a machinist to pull the outside chamfering tool 19 out of a collet without gripping the sharp cutting bits 30-33. In the embodiment shown the middle section 21 is smooth but could also be knurled to provide an easier surface to grip. On the top 24 of the outside chamfering tool 19 there is a recessed hole 23 (better shown and described in FIGS. 7 and 8) where the cutting bits 30-33 are set. The four cutting bits 30-33 are essentially the same size and shape. They have been set into the recess in 90 degree increments of rotation. The cutting bits 30-33 are preferably made from hardened steel to provide a longer service life, while the bit holder is preferably made from a more ductile material.

Referring now to FIG. 4, viewing at the bottom of the outside chamfering tool 19, a hole 26 is visible that passes from the bottom 25 of the holder into the recess 23. Through this hole the four (unnumbered) cutting bits are visible. This hole 26 allows for insertion of a removal tool to push the cutting bits out of the holder thereby eliminating the need of a machinist to physically grip the sharp cutting edges to pull the cutting bits out of the holder. The outside chamfering tool 19 can be made of nearly any size and is scalable in design for both the maximum chamfering side and the chamfering angle.

FIG. 5 shows a top view of the outside chamfering tool 19. From this top view the cutting bits 30-33 are shown placed at 90 degree intervals within the recess 23 of the holder. From this view the cutting angles appear unnoticeable. In one embodiment a sharpened edge is placed on the cutting bit. This is shown as line 35 on cutting bit 31 for reference. The cutting bits 30-33 are preferable held within the outside chamfering tool 19 by frictional forces but could also be retained by tapping and treading the cutting bits into the holder from below or by the use of set screws from the sides of the holder. In working samples, forces on the cutting surface force the cutting bit into the holder where they are maintained without rotational motion within the pocket 23 of the holder.

FIG. 6 shows a cross-sectional view of the outside chamfering tool 19 from FIG. 5. This view only shows cross-sectional lines in the holder because the cutting plane of exists between the two cutting bits. This cross-sectional view shows that the tool holder has essentially an elongated cylindrical body with a first end 20 having a cylindrical shaft 20 that fits within the chuck, collet or other similar tool holder. The cylindrical shaft 20 has a bottom 25 that is essentially flat. The cylindrical shaft further has a shoulder 22 to prevent inserting the outside chamfering tool 19 too far into a collet or chuck.

The middle section 21 of the outside chamfering tool 19 has straight walls that allow a machinist to pull the outside chamfering tool 19 out of a collet without gripping the sharp cutting bits 30-33. In the embodiment shown the middle section 21 is smooth but could also be knurled to provide an easier surface to grip. On the top 24 of the outside chamfering tool 19 there is a recessed hole 23 where the cutting bits 31, 32 are set. The hole 26 is visible that passes from the bottom 25 of the holder into the recess 23. Through this hole the four (unnumbered) cutting bits are visible. This hole 26 allows for insertion of a removal tool to push the cutting bits out of the holder thereby eliminating the need of a machinist to physically grip the sharp cutting edges to pull the cutting bits out of the holder.

FIG. 7 shows a perspective view of just the holder showing the holder without cutting bits installed in the holder. The internal features are shown with broken lines to show that the holder has a shank 20 for gripping and a recessed pocket 23 where the cutting bits are inserted. FIG. 8 shows a perspective view of the tool holder with a single cutter 31 installed in the holder. The inclusion of a single cutter 31 in the holder provides a visual indicator of the cutting surfaces and how a single cutter 31 is nested in the recessed pocket 23. The remaining three cutting bits would be placed around the shown cutting bit 31 at 90 degree increments. The shank 20, lip 22, middle side wall 21, upper lip 24 and the bottom of the recess pocket is shown and described previously herein.

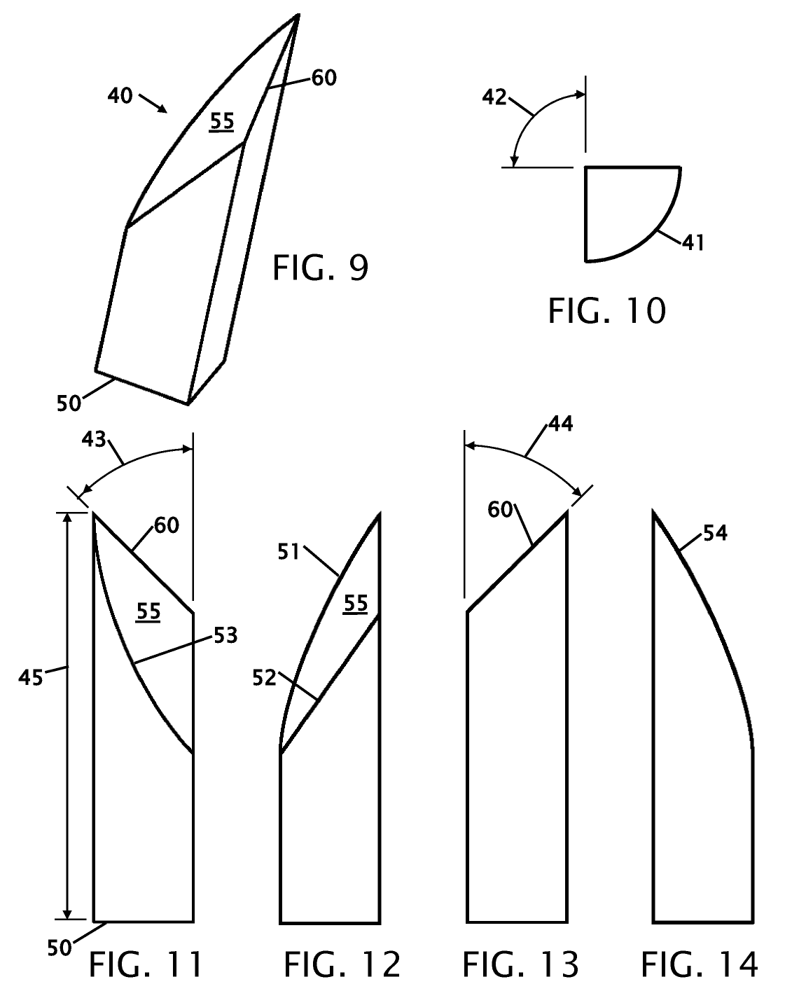

FIG. 9 shows a perspective view of a single cutter 40 and FIG. 10 shows a top or bottom view of a single cutter 40. From FIG. 9 the primary cutting edge 60 is shown as the clearance surface 55 is shown angled or drafting away. FIG. 10 is shown as a top or bottom view because from the bottom view the cutting bit is flat, and from the top view the cutting angle is tapered away and appears planar. The cutting bits can be cut or ground as square tool bit and then collectively ground with an outside radius 41 that fits within the pocket of the holder. This maintains the 90 degree 42 nesting angle of the cutting bits so each of the cutting bits can sit on the flat bottom 50 of the cutting bit(s) in the tool holder. While a 90 degree angle is shown, it is contemplated that three cutting bits with 120 degrees could be used or more than four cutting buts can be used, as a further example, six cutting bits at 60 degrees. FIGS. 11 to 14 show the side views of the cutting bit. All four cutting bits are machined or ground to an identical cutting and relief angle(s).

FIG. 11 shows a first side view of a single cutter, FIG. 12 shows a second side view of a single cutter, FIG. 13 shows a third side view of a single cutter and FIG. 14 shows a fourth side view of a single cutter. While specific angles are identified they should be viewed as reference and angles of greater or lesser are contemplated without departing from the inventive concept. The cutting or relief angle 60 is essentially a 45 degree angle, but can be ground to any preferred angle cut in two directions 43 and 44 from an end of the cutting bit 40 to form the clearance surface 55 for chip removal. The height 45 of the cutting bit 40 from the bottom 50 to the top of the cutting bit is sufficient to allow a desirable amount to exist above the outer surface of the holder. The side profiles in FIGS. 11, 12 and 14 show a radius 53, 51 and 54 respectively as the cutting angle 60 dissipates into the radius of the cutting bit. Form FIG. 12, the compound cutting angle forms an angle 52 on the surface normal to the cutting edge 60.

Thus, specific embodiments of an outside chamfering tool have been disclosed. It should be apparent, however, to those skilled in the art that many more modifications besides those described are possible without departing from the inventive concepts herein. The inventive subject matter, therefore, is not to be restricted except in the spirit of the appended claims.

1. An outside chamfering tool comprising:
a tool holder having an elongated shank with a first end having an outer diameter;
said tool holder further having a second end with a recessed pocket;
said recessed pocket configured for receiving a plurality of replaceable cutting bits, and
said cutting bit being removable retained in said recessed pocket and having at least one angled cutting surface.

2. The outside chamfering tool according to claim 1 wherein there are four cutting bits.

3. The outside chamfering tool according to claim 2 wherein said cutting bits are configured in 90 degree sectors and nest in said recessed pocket.

4. The outside chamfering tool according to claim 1 wherein said cutting bit has two sides that are perpendicular and an arc that has a radius that is equal to a radius on either of said two sides.

5. The outside chamfering tool according to claim 1 wherein said at least one cutting angle is flat.

6. The outside chamfering tool according to claim 2 wherein all four cutting bits are identical.

7. The outside chamfering tool according to claim 2 wherein said four cutting bits are placed into said holder rotated 90 degrees.

8. The outside chamfering tool according to claim 1 wherein the at least one cutting bit is hardened material.

9. The outside chamfering tool according to claim 1 wherein said at least one cutting bit is harder than the tool holder.

10. The outside chamfering tool according to claim 1 wherein said tool cuts an outside chamfer on round stock.

11. The outside chamfering tool according to claim 10 wherein said outside chamfering tool is secured in a tale stock of a lath.

12. The outside chamfering tool according to claim 10 wherein outside chamfering tool is securable in a head stock of a lath.

13. The outside chamfering tool according to claim 10 wherein outside chamfering tool is securable in a collet of a mill.

14. The outside chamfering tool according to claim 2 wherein said four cutting bits are retained by friction with said recessed pocket.

15. The outside chamfering tool according to claim 1 wherein said four cutting bits are manually pushed or pulled from the recessed pocket.

16. The outside chamfering tool according to claim 1 wherein outside chamfer machines material to a point.

17. The outside chamfering tool according to claim 1 wherein said cutting bits are re-sharp enable.

18. The outside chamfering tool according to claim 1 wherein the tool holder has a shoulder to prevent over-insertion of the tool holder into a collet or chuck.

19. The outside chamfering tool according to claim 1 wherein the shoulder allows a person the hold the tool holder without gripping the cutting bits.

20. The outside chamfering tool according to claim 1 further includes a central through hole to allow a user to push the cutting bit out of the recessed pocket.
